(19) United States
(12) Patent Application Publication
(10) Pub. No.: US 2017/0021662 A1
(43) Pub. Date: Jan. 26, 2017

(54) System and Method for Training Correct Positioning and Pressure of Digits on a Marking Instrument

(71) Applicants: Tyler S. Forester, Claremont, CA (US); Leah K. H-J. Forester, Claremont, CA (US)

(72) Inventors: Tyler S. Forester, Claremont, CA (US); Leah K. H-J. Forester, Claremont, CA (US)

(21) Appl. No.: 15/217,870

(22) Filed: Jul. 22, 2016

Related U.S. Application Data
(60) Provisional application No. 62/196,869, filed on Jul. 24, 2015.

(51) Int. Cl. B43K 8/22; G06F 3/038; G06F 3/0354; G09B 11/00; B43K 29/08

(52) U.S. Cl. CPC B43K 8/22; G09B 11/00; B43K 29/08; G06F 3/03545; G06F 3/0383

(57) ABSTRACT

A system and method for training correct positioning and pressure of digits on a marking instrument helps teach correct positioning and pressure of digits on a marking instrument, and a correct marking angle of the marking instrument relative to a reference plane. The system provides an electronic marking instrument having pressure sensors that detect the position and a predetermined, uniform pressure from three digits. The marking instrument further comprises tilt sensor that measures the marking angle of the marking instrument to determine whether a predetermined marking angle, between 45 to 90 degrees has been achieved. A determination of a predetermined pressure by the digits, and a predetermined marking angle of the marking instrument actuates a marking portion on the marking instrument to enable marking. However, a determination of an improper position and pressure of the digits and orientation of the marking instrument deactivates the marking portion to restrict marking.

### CROSS REFERENCE OF RELATED APPLICATIONS

This application claims the benefits of U.S. provisional application no. 62/196,869, filed Jul. 24, 2015, and entitled SYSTEM AND METHOD FOR TEACHING POSTURE AND POSITIONING FOR MARKING WITH A STYLUS, which provisional application is incorporated by reference herein in its entirety.

### FIELD OF THE INVENTION

The present invention relates generally to a system and method for training correct positioning and pressure of digits on a marking instrument. More so, a system and method provides a marking instrument, such as an electronic stylus, having a plurality of sensors that detect the position and pressure from three digits positioned on the marking instrument, and the marking angle or orientation of the marking instrument relative to a reference plane to determine whether a proper pressure by the digits, and an appropriate marking angle by the marking instrument relative to a reference plane has been achieved; whereby a determination of a predetermined pressure and marking angle actuates a marking portion of the marking instrument to enable marking; whereby a determination of an improper pressure and marking angle deactivates the marking portion to restrict marking.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, a writing instrument is an object used to produce writing. Most writing instruments can be also used for other functions such as painting, drawing, and technical drawing, but writing instruments generally have the ordinary requirement to create a smooth, controllable line. One particular type of writing instrument is a stylus. A stylus is a writing utensil, or a small tool for some other form of marking or shaping, for example in pottery. It can also be a computer accessory that is used to assist in navigating or providing more precision when using touchscreens. It usually refers to a narrow elongated staff, similar to a modern ballpoint pen.

Often, the writing instrument is held between-the thumb and forefinger. While it is possible to hold the pencil with these two digits alone by applying their pressure against diametrically opposed portions of the pencil, in the great majority of instances, they are not thus supported, but are so held that the writing instrument bears with considerable pressure against the middle finger causing it to cooperate in the support of the pencil.

Further, the extent to which marking or writing involves movement of the writing instrument holding digits is another factor contributing to fatigue in writing, but the controlling factor is the pressure of the thumb and forefinger which, when not applied against diametrically opposed portions of the implement, cause excessive fatigue.

Often, fatigue incident to extensive writing is commonly experienced. While such fatigue depends on many factors among which the writer's manner of holding the pencil or pen is important, the digital pressures exerted in the support of the writing implement are such that writer's cramp is not unusual and callouses are commonly experienced.

Typically, teaching a toddler the correct finger placements for gripping an implement such as a pencil, crayon, fork or the like is important in mastering the use of the particular implement. Proper use of the implement will bolster self-confidence and encourage continued use, thus possibly enhancing intellectual curiosity and social skills.

It is known in the art that consistency based on muscle memory is a major problem in teaching the above-mentioned finger placement in that the fingers and thumb should be positioned at approximately the same place on the implement at each use. Consistent finger placement positioning is a learned skill that is developed over time by repeated practice. A training device that would speed up the learning curve while instilling confidence in the toddler would be a welcome developmental tool in the art.

Other proposals have involved writing instruments that taught appropriate hand position. The problem with these training devices is that they do not take into account both the pressure applied to the writing instrument and the angle of the writing instrument relative to a reference plane, such as a tablet or paper that is being marked. Even though the above cited handwriting training devices meets some of the needs of the market, a system and method for training correct positioning and pressure of digits on a marking instrument that utilizes pressure sensors to detect pressure from three digits positioned on the marking instrument, and a tilt sensor to measure the marking angle of the marking instrument relative to a reference plane, so as to determine whether a predetermined pressure and marking angle has been achieve to actuate a marking portion of the marking instrument and enable marking, is still desired.

### SUMMARY OF THE INVENTION

Illustrative embodiments of the disclosure are generally directed to system and method for training correct positioning and pressure of digits on a marking instrument. The system and method for training correct positioning and pressure of digits on a marking instrument is configured to help train the digits and the orientation and position of a hand while gripping a marking instrument and marking. This enables the marking instrument to be gripped while writing, such that the user's hand position is more relaxed, and a more efficient, ergonomic writing style is employed.

In one embodiment, the system and method helps to the correct positioning and pressure of digits on a marking instrument, and correct orientation of the marking instrument relative to a reference plane, such that the marking instrument can be gripped by a user to provide the user with a hand position which is more relaxed and ergonomic.

In one aspect of the proper position of the digits, the index finger becomes a guide finger, while the middle finger and thumb stabilize the marking instrument during marking. The marking instrument rests near the knuckle of the middle finger, while the fleshy bit of the tip of the index finger keeps the marking instrument moving in the desired marking motion.

The system may include an electronic marking instrument having a plurality of pressure sensors that detect the position and pressure from three digits to determine if a predetermined pressure, which is generally uniform, has been applied to the marking instrument by the digits. Thus, the marking instrument non-forcibly guides the digits into a position where a relevant portion of the digit is aligned with the pressure sensor so that the relevant portion of the digits correlate with generally same relevant portions of the pressure sensors.

The marking instrument further comprises tilt sensor that measures the marking angle of the marking instrument relative to a reference plane to determine whether a predetermined marking angle of the marking instrument has been achieved. The reference plane may include a tablet, digital display, a paper, and a board on which the marking instrument marks. The combination of a predetermined position of the digits and a predetermined orientation of the hand enables optimal marking capacity.

A determination of a predetermined pressure by the digits, and a predetermined marking angle of the marking instrument triggers a marking portion on the marking instrument to enable marking. However, a determination of an improper position and pressure of the digits and orientation of the marking instrument deactivates the marking portion, thereby inhibiting marking by the marking instrument. In this manner, a hand is trained to apply the digits in the proper pressure and position on the pressure sensors, and orient the marking instrument in the proper orientation relative to the reference plane to enable the marking instrument to produce a mark.

In one embodiment, the predetermined pressure is applied to the pressure sensors when the plurality of pressure sensors register approximately the same pressure from the plurality of digits. In another embodiment, the predetermined marking angle is about between 90° to 45° from the reference plane.

The system may further include a circuit that is configured to close when the plurality of digits apply the predetermined pressure on the plurality of pressure sensors, and when the tilt sensor measures the predetermined marking angle by the longitudinal axis of the marking instrument. The closed circuit actuates the marking portion to produce the mark.

Conversely, the circuit is configured to open when the plurality of digits fail to register the predetermined pressure on the plurality of pressure sensors, and when the tilt sensor fails to register the predetermined marking angle, whereby the open circuit deactivates the marking portion to restrict producing the mark.

Those skilled in the art will recognize that the thumb provides stability and support for the marking instrument. Thus, all three fingers are in motion while marking with the marking instrument. Furthermore, the pressure sensors are disposed centrally along the length of the marking instrument, so as to inhibit grasping of the marking instrument too close or too far from the distal end of the marking instrument.

One objective of the present invention is to provide a marking instrument that trains the hand and digits to properly hold a marking instrument while producing marks.

Another objective is to enable the marking instrument to be gripped while writing, such that the user's hand position is more relaxed, and a more efficient, ergonomic writing style is employed.

Another objective is to provide a plurality of pressure sensors that detect that a uniform pressure is applied to the marking instrument by the index finger, middle finger, and thumb.

Another objective is to provide a tilt sensor that measures the angle of the longitudinal axis of the marking instrument relative to a reference plane.

Another objective is to provide a circuit that is triggered to open for actuating the marking portion when the predetermined pressure and orientation are achieved.

Another objective is to provide an inexpensive to manufacture marking instrument for teaching proper marking posture and position.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a side perspective view of an exemplary marking instrument for use in a system for training correct positioning and pressure of digits on a marking instrument, in accordance with an embodiment of the present invention;

FIG. 2 illustrates a top angle perspective view of the marking instrument, in accordance with an embodiment of the present invention;

FIG. 3 illustrates a top view of the marking instrument, in accordance with an embodiment of the present invention; and

FIG. 4 illustrates a flowchart diagram of an exemplary method for training correct positioning and pressure of digits on a marking instrument, in accordance with an embodiment of the present invention.

Like reference numerals refer to like parts throughout the various views of the drawings.

### DETAILED DESCRIPTION OF THE INVENTION

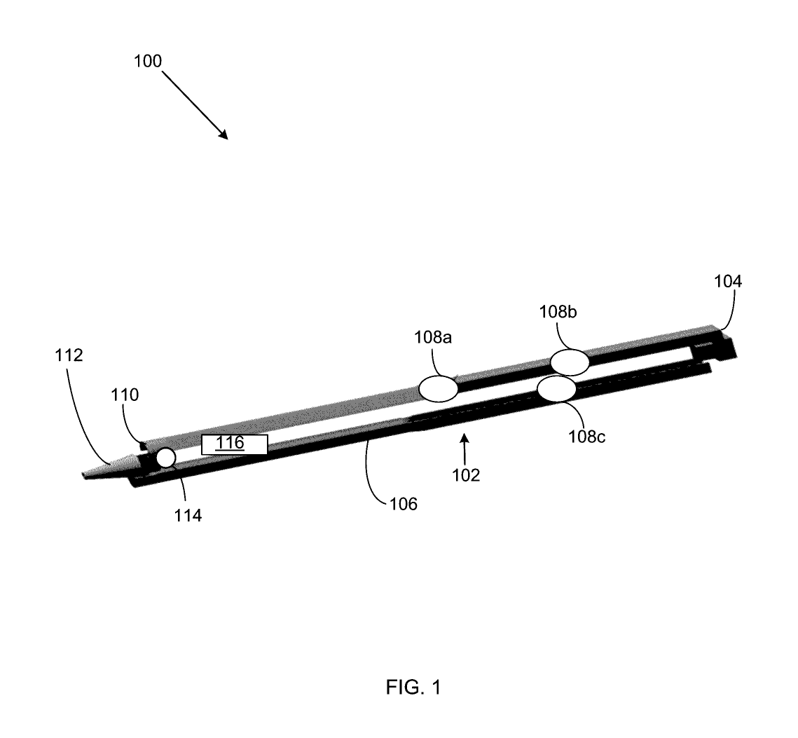

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “first,” “second,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. §112.

In one embodiment of the present invention presented in FIGS. 1-4, a system 100 and method 200 for training correct positioning and pressure of digits on a marking instrument 102 is configured to help train the digits to a predetermined position, and the hand to a predetermined orientation while gripping a marking instrument 102 and marking. This enables the marking instrument 102 to be gripped while writing, such that the user's hand position is more relaxed, and a more efficient, ergonomic writing style is employed.

This creates an optimal marking style that is useful for enhanced and ergonomic writing in numerous marking environments in which proper digit position and hand orientation is required. For example, the marking instrument 102 may include, without limitation, an electronic stylus, a mechanical stylus, a pen, a pencil, a color marker, a paint brush, a crayon, and an eating utensil for a toddler.

Those skilled in the art will recognize that consistency based on muscle memory is a major problem in teaching proper finger placement in that the fingers and thumb should be positioned at approximately the same place on the implement at each use. Consistent finger placement positioning is a learned skill that is developed over time by repeated practice. The system 100 helps to the correct positioning and pressure of digits on a marking instrument 102, and correct orientation of the marking instrument 102 relative to a reference plane, such that the marking instrument 102 can be gripped by a user to provide the user with a hand position which is more relaxed and ergonomic. This can be repeated to train the digits and hand to consistent marking.

The marking instrument 102 comprises a plurality of pressure sensors 108a-c that detect the position and pressure from three digits to determine if a predetermined pressure has been applied to the marking instrument 102 by the digits. Thus, the marking instrument non-forcibly guides the digits into a position where a relevant portion of the digit is aligned with the pressure sensors 108a-c, such that the relevant portion of the digits correlate with generally same relevant portions of the pressure sensors 108a-c.

The predetermined pressure may be defined as application of pressure to each pressure sensor 108a-c in an approximately uniform manner that allows the hand and digits to form a continuous line with the marking instrument 102.

The marking instrument 102 further comprises tilt sensor 114 that measures the orientation of the marking instrument relative to the reference plane to determine whether a predetermined marking angle of the marking instrument has been achieved. The combination of a predetermined position of the digits and a predetermined orientation of the hand enables optimal marking capacity.

To help train a desired orientation of the marking instrument 102 while marking, the marking instrument 102 further comprises tilt sensor 114 that measures the orientation of the marking instrument 102 relative to the reference plane to determine whether a predetermined marking angle of the marking instrument 102 has been achieved.

The predetermined marking angle of the marking instrument 102 relative to the reference plane may be defined as an angle of the longitudinal axis of the marking instrument 102 approximately between 45° to 90° relative to the reference plane. Though, depending on the type of marking instrument 102, other embodiments may require greater or lesser marking angles.

A determination of a predetermined position and pressure by the digits, and a predetermined marking angle of the marking instrument 102 triggers a marking portion 112 on the marking instrument 102 to enable marking. However, a determination of an improper position and pressure of the digits and orientation of the marking instrument 102 deactivates the marking portion 112, thereby inhibiting marking by the marking instrument 102.

In one embodiment, the predetermined pressure is applied when the plurality of pressure sensors register approximately the same pressure from the plurality of digits. In another embodiment, the predetermined marking angle is about between 90° to 45° from the reference plane.

The system 100 may further include a circuit (not shown) that is configured to close when the plurality of digits apply a predetermined pressure on the pressure sensors 108a-c, and when the tilt sensor 114 measures a predetermined marking angle by the longitudinal axis of the marking instrument. The closed circuit actuates the marking portion to produce the mark.

Conversely, the circuit is configured to open when the plurality of digits fail to register the predetermined pressure on the pressure sensors 108a-c, and when the tilt sensor 114 fails to register the predetermined marking angle, whereby the open circuit deactivates the marking portion to restrict producing the mark.

In this manner, a hand and the accompanying fingers are trained to apply the proper pressure and position on the pressure sensors 108a-c, and orient the marking instrument 102 in the proper marking angle relative to the reference plane to enable the marking instrument 102 to produce a mark.

Those skilled in the art, in light of the present teachings, will recognize that the proper marking technique requires the digits to be positioned at specific points along a longitudinal axis 106 of the marking instrument 102. Additionally, the pressure from the digits must be evenly distributed between the three digits along the length of the marking instrument 102. In one embodiment, the three digits includes the index finger, the middle finger, and the thumb.

In one aspect of the proper position of the digits, the index finger becomes a guide finger, while the middle finger and thumb stabilize the marking instrument 102 during marking. The marking instrument 102 rests near the knuckle of the middle finger, while the fleshy bit of the tip of the index finger keeps the marking instrument 102 moving in the desired marking motion.

Those skilled in the art will recognize that the thumb provides stability and support for the marking instrument 102. Thus, all three fingers are in motion while marking with the marking instrument 102. Furthermore, the pressure sensors 108a-c are disposed centrally along the length of the marking instrument 102, so as to inhibit grasping of the marking instrument 102 too close or too far from the distal end 110 of the marking instrument 102.

As illustrated in FIG. 1, a system 100 for training correct positioning and pressure of digits on a marking instrument provides a marking instrument 102 that senses pressure from a plurality of digits and measures the marking angle of the marking instrument 102 to activate and deactivate marking by the marking instrument 102. The system 100 is especially effective for teaching children and students the proper writing posture and positions for enhanced hand writing. In some embodiments, the marking instrument 102 may include an electronic marking instrument 102 used to mark a display on a tablet. Though in other embodiments, any elongated marking instrument may be utilized in the system 100.

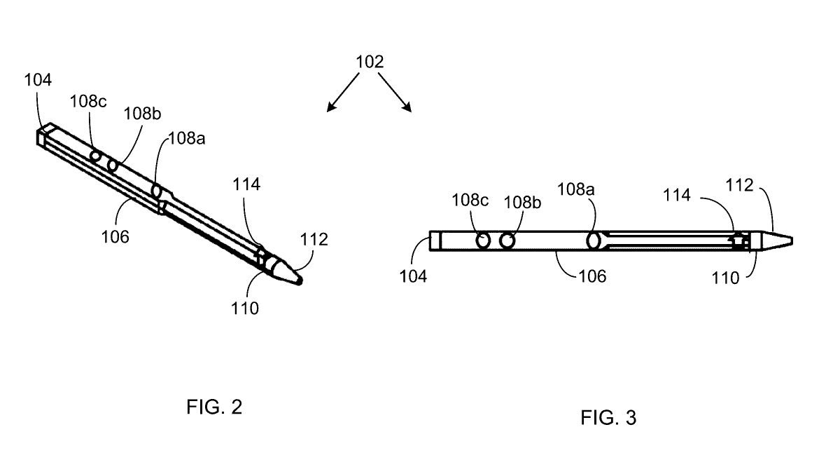

Turning now to FIG. 2, the marking instrument 102 is defined by a proximal end 104, a longitudinal axis 106, and a distal end 110. The proximal end 104 and the distal end 110 form termini, while the longitudinal axis 106 forms an elongated shaft having a diameter that enables a hand to grip. The longitudinal axis 106 of the marking instrument 102 comprises a plurality of pressure sensors 108a-c. The pressure sensors 108a-c are disposed along the longitudinal axis 106 of the marking instrument 102.

The pressure sensors 108a-c are configured to enable detection of a predetermined pressure from a plurality of digits. The digits may include an index finger that correlates to pressure sensor 108a, a middle finger that correlates to pressure sensor 108b, and a thumb that correlates to pressure sensor 108c. Thus, the pressure sensors 108a-c detect the uniformity of the pressure applied thereon. The predetermined pressure indicates a correct position of the digits on the marking instrument 102. In one possible embodiment, the pressure sensors 108a-c comprise three nano push buttons. Though in other embodiments, various types of pressure sensors sensitive enough to detect digits may be used.

In some embodiments, the distal end 110 of the marking instrument 102 comprises a tilt sensor 114. The tilt sensor 114 is configured to measure the predetermined marking angle of the longitudinal axis 106 of the marking instrument 102 relative to a reference plane. The reference plane may include a tablet, digital display, a paper, and a board on which the marking instrument 102 marks. In this manner, the tilt of the marking angle, or orientation of the marking instrument 102, while being held by the digits, can be measured.

Thus, the tilt sensor 114 detects the marking angle, or orientation of the marking instrument 102. A predetermined marking angle indicates a correct position of the marking instrument 102, and may be approximately between 45° to 90° relative to the reference plane. Thus, both the predetermined pressure by the digits and the predetermined marking angle of the marking instrument 102 indicates a correct writing position and posture. In one possible embodiment, the tilt sensor 114 is a ball tilt sensor 114. Though, in other embodiments, an accelerometer may also be used in place of the tilt sensor 114.

As shown in FIG. 3, the distal end 110 of the marking instrument 102 may further include a marking portion 112. The marking portion 112 is disposed at the distal end 110 of the marking instrument 102 for producing a mark on the reference plane. In one embodiment, the marking portion 112 is a fine writing tip. The marking portion 112 serves three general functions: 1) forming a fine-writing tip; 2) enabling a power on and power off function; and 3) allowing for the functionality of palm rejection functions.

The marking instrument 102 further carries a circuit. The circuit operatively connects to the plurality of pressure sensors 108a-c, the tilt sensor 114, and the marking portion 112. The circuit may include, without limitation, wires, resistors, and capacitors. It is the circuit that actuates or restricts the marking portion 112 in producing marks. The circuit is configured to close when the plurality of digits apply a predetermined pressure on the plurality of pressure sensors 108a-c, and when the tilt sensor 114 measures a predetermined marking angle by the longitudinal axis 106 of the marking instrument 102. The closed circuit enables power to reach the marking portion 112. In this manner, the closed circuit actuates the marking portion 112 to produce the mark on the reference plane.

However, when the predetermined pressure and positioning of the digits is not achieved with the digits and the marking angle of the longitudinal axis 106 of the marking instrument 102, the circuit remains open; and thus, the marking portion 112 is inoperable. For example, in one possible embodiment, when the marking instrument 102 is in the appropriate writing position, the tilt sensor 114 activates. However, if the marking angle of the longitudinal axis 106 of the marking instrument 102 is not approximately between 45° to 90°, the circuit remains open and the marking instrument 102 is inoperable.

However, in one alternative embodiment, the marking portion 112 of the marking instrument 102 may still product a mark when the circuit is open, but will also emit an error message. The error message indicates that the pressure on the pressure sensors is outside the predetermined pressure, or the marking angle is outside the predetermined marking angle, or both. In this manner, the marking instrument still operates when held or oriented incorrectly, but informs the user of the incorrect pressure and marking angle. In another possible embodiment, a mechanical switch may be altered in a more advanced production.

In some embodiments, the system 100 may utilize a power source 116 to power the plurality of pressure sensors 108a-c, the tilt sensor 114, and the circuit. The power source 116 may include, without limitation, a portable battery, a rechargeable battery, an external power cord, and a solar cell. In one alternative embodiment, the marking instrument 102 receives power from a magnetic field that is generated by the digital display of a tablet. In conclusion, the marking instrument 102 is designed to stop writing when the hand position is not correct, thus forcing the hand to hold the marking instrument 102 properly.

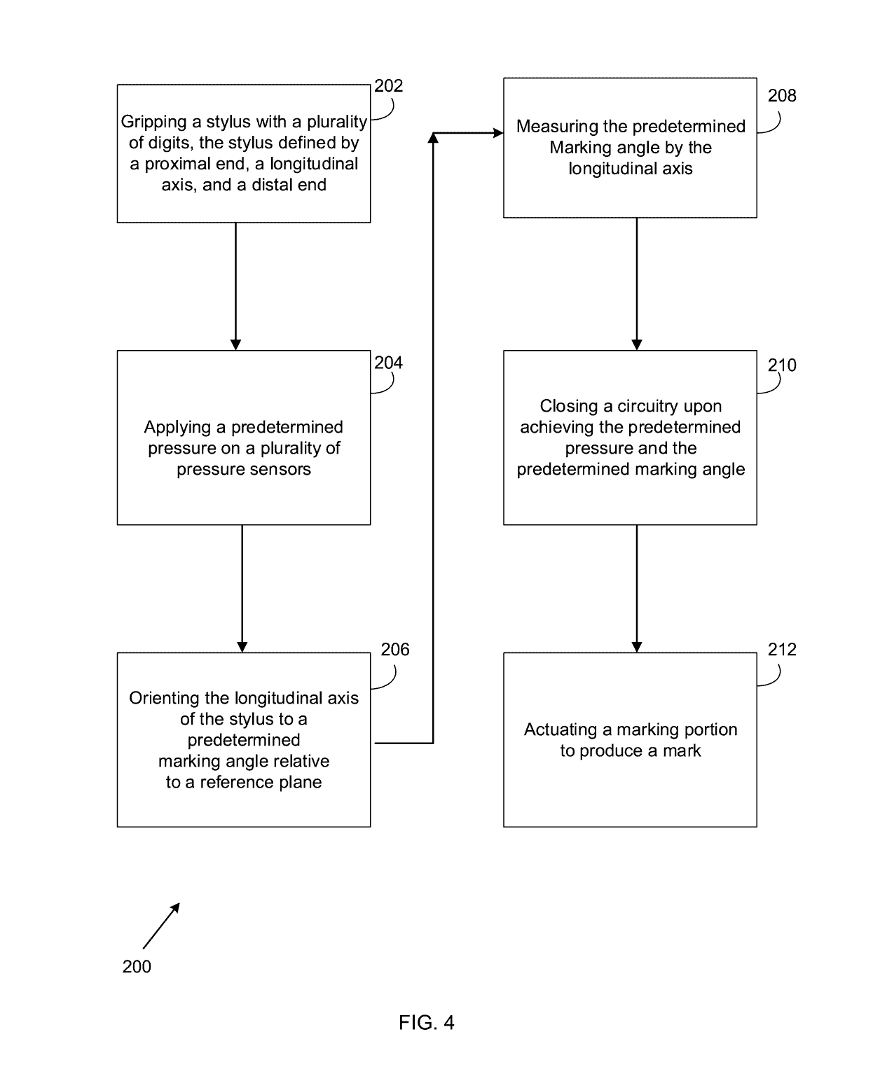

As referenced in FIG. 4, a method 200 for training correct positioning and pressure of digits on a marking instrument, comprises an initial Step 202 of gripping a marking instrument 102 with a plurality of digits, the marking instrument 102 defined by a proximal end 104, a longitudinal axis 106, and a distal end 110. The proximal end 104 and the distal end 110 form the termini, while the longitudinal axis 106 forms an elongated shaft having a diameter sufficient for enabling a hand to grip the longitudinal axis 106 of the marking instrument 102. A Step 204 may include applying a predetermined pressure on a plurality of pressure sensors 108a-c. The longitudinal axis 106 of the marking instrument 102 comprises a plurality of pressure sensors 108a-c. The pressure sensors 108a-c are disposed along the longitudinal axis 106 of the marking instrument 102. In one possible embodiment, the pressure sensors 108a-c comprise three nano push buttons positioned to guide the index finger, the middle finger, and the thumb.

In some embodiments, the method 200 may include a Step 206 of orienting the longitudinal axis 106 of the marking instrument 102 to a predetermined marking angle relative to a reference plane. The reference plane may include a tablet, digital display, a paper, and a board on which the marking instrument 102 marks. The marking angle may be approximately between 45° to 90° relative to the reference plane. A Step 208 comprises measuring the predetermined marking angle by the longitudinal axis 106. The tilt sensor 114 is configured to measure the marking angle of the longitudinal axis 106 of the marking instrument 102 relative to a reference plane. In this manner, the tilted angle, or marking angle of the marking instrument 102, while being held by the digits, can be measured. Thus, the tilt sensor 114 detects the marking angle of the marking instrument 102. A predetermined marking angle indicates a correct position of the marking instrument 102. Thus, both the predetermined pressure by the digits and the predetermined marking angle of the marking instrument 102 indicates a correct writing position and posture.

A Step 210 may further include closing a circuit upon achieving the predetermined pressure and the predetermined marking angle. The circuit operatively connects to the plurality of pressure sensors 108a-c, the tilt sensor 114, and the marking portion 112. The circuit is configured to close when the plurality of digits apply a predetermined pressure on the pressure sensors 108a-c, and when the tilt sensor 114 measures the predetermined marking angle by the longitudinal axis 106 of the marking instrument 102. A final Step 212 comprises actuating a marking portion 112 to produce a mark. The mark may include a letter, image, or pattern that is formed on a digital display. The marking instrument 102 is inoperable to produce the mark if the posture and position is incorrect; thereby training the hand and digits to properly hold a marking instrument, such as an electronic stylus, while producing marks.

However, in one alternative embodiment, the marking portion 112 of the marking instrument 102 may still product a mark when the circuit is open, but will also emit an error message. The error message indicates that the pressure on the pressure sensors is outside the predetermined pressure, or the marking angle is outside the predetermined marking angle, or both. In this manner, the marking instrument still operates when held or oriented incorrectly, but informs the user of the incorrect pressure and marking angle.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A system for training correct positioning and pressure of digits on a marking instrument, the system comprising:
a marking instrument, the marking instrument defined by a proximal end, a longitudinal axis, and a distal end;
a plurality of pressure sensors, the plurality of pressure sensors disposed along the longitudinal axis of the marking instrument, the plurality of pressure sensors configured to enable detection of pressure from a plurality of digits;
a tilt sensor, the tilt sensor disposed at the distal end of the marking instrument, the tilt sensor configured to enable measurement of a marking angle of the longitudinal axis of the marking instrument relative to a reference plane;
a marking portion, the marking portion disposed at the distal end of the marking instrument, the marking portion configured to produce a mark; and
a circuit, the circuit configured to operatively connect to the plurality of pressure sensors.

2. The system of claim 1, wherein the marking instrument includes at least one member selected from the group consisting of: an electronic stylus, a mechanical stylus, a pen, a pencil, a color marker, a paint brush, and a crayon.

3. The system of claim 1, wherein the plurality of pressure sensors comprise three nano push buttons or an accelerometer or both.

4. The system of claim 1, wherein the tilt sensor comprises a ball tilt sensor or a gyroscope or both.

5. The system of claim 1, wherein the reference plane includes at least one member selected from the group consisting of: a tablet, digital display, a paper, and a board on which the marking instrument marks.

6. The system of claim 1, wherein the marking portion comprises a fine writing tip.

7. The system of claim 1, wherein the marking portion is configured to allow for the functionality of a palm rejection function.

8. The system of claim 1, wherein the plurality of digits comprises an index finger, a middle finger, and a thumb.

9. The system of claim 1, wherein the circuit is configured to close when the plurality of digits apply a predetermined pressure on the plurality of pressure sensors, and when the tilt sensor measures a predetermined marking angle by the longitudinal axis of the marking instrument, whereby the closed circuit actuates the marking portion to produce the mark,

10. The system of claim 10, wherein the circuit is configured to open when the plurality of digits fail to register the predetermined pressure on the plurality of pressure sensors, and when the tilt sensor fails to register the predetermined marking angle, whereby the open circuit deactivates the marking portion to restrict producing the mark.

11. The system of claim 11, wherein the predetermined pressure is applied when the plurality of pressure sensors register approximately the same pressure from each of the plurality of digits.

12. The system of claim 12, wherein the predetermined marking angle is applied when the longitudinal axis of the marking instrument is about between 45 degrees to 90 degrees from the reference plane.

13. The system of claim 1, wherein the marking portion is configured to produce the mark and emit an error signal when the circuit is open.

14. A system for training correct positioning and pressure of digits on a marking instrument, the system comprising:
a marking instrument, the marking instrument defined by a proximal end, a longitudinal axis, and a distal end;
a plurality of pressure sensors, the plurality of pressure sensors disposed along the longitudinal axis of the marking instrument, the plurality of pressure sensors configured to enable detection of pressure from a plurality of digits;
a tilt sensor, the tilt sensor disposed at the distal end of the marking instrument, the tilt sensor configured to enable measurement of a marking angle of the longitudinal axis of the marking instrument relative to a reference plane;
a marking portion, the marking portion disposed at the distal end of the marking instrument, the marking portion configured to produce a mark;
a circuit, the circuit configured to operatively connect to the plurality of pressure sensors, the tilt sensor, and the marking portion,
the circuit further configured to close when the plurality of digits apply a predetermined pressure on the plurality of pressure sensors, and when the tilt sensor measures a predetermined marking angle by the longitudinal axis of the marking instrument, whereby the closed circuit actuates the marking portion to produce the mark,
the circuit further configured to open when the plurality of digits fail to register the predetermined pressure on the plurality of pressure sensors, and when the tilt sensor fails to register the predetermined marking angle, whereby the open circuit deactivates the marking portion to restrict producing the mark; and
a power source, the power source configured to power the plurality of pressure sensors, the tilt sensor, and the circuit.

15. The system of claim 14, wherein the plurality of pressure sensors comprise three nano push buttons or an accelerometer or both.

16. The system of claim 15, wherein the predetermined pressure is applied when the plurality of pressure sensors register approximately the same pressure from each of the plurality of digits.

17. The system of claim 16, wherein the predetermined marking angle is applied when the longitudinal axis of the marking instrument is about between 45 degrees to 90 degrees from the reference plane.

18. A method for training correct positioning and pressure of digits on a marking instrument, the system comprising:
gripping a marking instrument with a plurality of digits, the marking instrument defined by a proximal end, a longitudinal axis, and a distal end;
applying a predetermined pressure on a plurality of pressure sensors;
orienting the longitudinal axis of the marking instrument to a predetermined marking angle relative to a reference plane;
measuring the predetermined marking angle of the longitudinal axis;
closing a circuit upon achieving the predetermined pressure and the predetermined marking angle; and
actuating a marking portion to produce a mark.

19. The system of claim 18, wherein the predetermined pressure is applied when the plurality of pressure sensors register approximately the same pressure from each of the plurality of digits.

20. The system of claim 19, wherein the predetermined marking angle is applied when the longitudinal axis of the marking instrument is about between 45 degrees to 90 degrees from the reference plane.
